(19) United States
(12) Patent Application Publication
(10) Pub. No.: US 2008/0126306 A1
(43) Pub. Date: May 29, 2008

(54) System and method for automatic configuration of network devices

(76) Inventor: Fatima Corona, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/604,951

(22) Filed: Nov. 28, 2006

(51) Int. Cl. G06F 17/30; G06F 15/177

(52) U.S. Cl. 707/3; 709/220; 707/E17.014

(57) ABSTRACT

A system and method for automatically configuring network devices having hardcopy output capability is disclosed. The method includes sending a broadcast message from a device newly added to a network seeking configuration parameters from other devices having similar device capabilities. The other devices send configuration parameter values to the newly added device. The newly added device receives the configuration parameters and sets its own parameters according to the those received from the other devices.

### BACKGROUND OF THE INVENTION

1. Field of the Invention

This application relates to configuration of network devices. More particularly, this application relates to a system and method for automatically configuring network-connected hardcopy output devices based on configuration parameter values obtained from other devices on the network.

2. Description of the Related Art

Currently, network hardcopy output devices that are connected to a network require users/administrators to manually input network configuration settings at the device. Device drivers may also need to be installed on a print/fax server so that other workstations or computing devices may access the hardcopy output device. Although there are current solutions that involve the use of remote control software to configure devices on the network, these solutions also require manual installation and configuration of the software on a workstation before it is capable of configuring newly added hardcopy output devices. Although installation and configuration of new software on network devices does not take an inordinate amount of time on a per device basis, as networks become larger, the amount of time required becomes significant. Moreover, these existing solutions require that a sophisticated user perform the configuration of the device, whether it be through some remote control software interface or manually at the device itself.

Therefore, it would be an improvement to provide a way for hardcopy output devices to be added to a network environment without needing any manual configuration or in networks with multiple hardcopy output devices, the man hours required to implement the devices on the network can become costly.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In one aspect, there is a method of configuring a device having a hardcopy output capability on a data communications network. The method may include searching the network for a configured device having a hardcopy output capability. The configured device may have configuration parameters applicable to the device. The method further may include finding the configured device on the network. Upon finding the configured device, values for the configuration parameters are obtained from the configured device. Based on the obtained values for the configuration parameters, the device is configured.

In another aspect, there is an automatically configurable network device having a hardcopy output capability. The device may include a network interface module configured to send and receive data from a data communications network. The device may also have a storage module configured to store instructions which when executed cause the network device to send a broadcast message to the network. A configuration module in the device may be configured to receive and store configuration settings received through the network interface module. The configuration settings may be received from another device on the network. The device may also include a user interface configured to display a notification when the network device is automatically configured.

### BRIEF DESCRIPTION OF THE DRAWINGS

In this description, reference is made to the drawings wherein like parts are designated with like numerals throughout.

FIG. 1 depicts various network components in a network environment suitable for practicing various aspects of the present invention.

FIG. 2A is a block diagram illustrating an example of a hardcopy output device from FIG. 1. FIG. 2B is a table of exemplary parameters and settings relating to a hardcopy output device.

FIGS. 3A and 3B provide illustrations of a network environment including several type of hardcopy output devices connected by a routing device.

FIGS. 4A and 4B are network environments similar to that shown in FIGS. 3A and 3B, but with only a single type of hardcopy output device.

FIG. 5 is a flowchart illustrating a process of configuring a hardcopy output device on a network.

FIG. 6 is a flowchart illustrating alternative process that may be used to automatically configure a device on a network.

### DETAILED DESCRIPTION OF CERTAIN INVENTIVE EMBODIMENTS

Various embodiments of the invention provide for a system and method of automatically configuring a hardcopy output device on a network without requiring physical access to the device by a sophisticated user such as a system administrator, for example. The systems and methods provided herein may be used to dramatically reduce the amount to time required to deploy network printers, fax machines, copiers, and other types of hardcopy output devices in multi-device network environments.

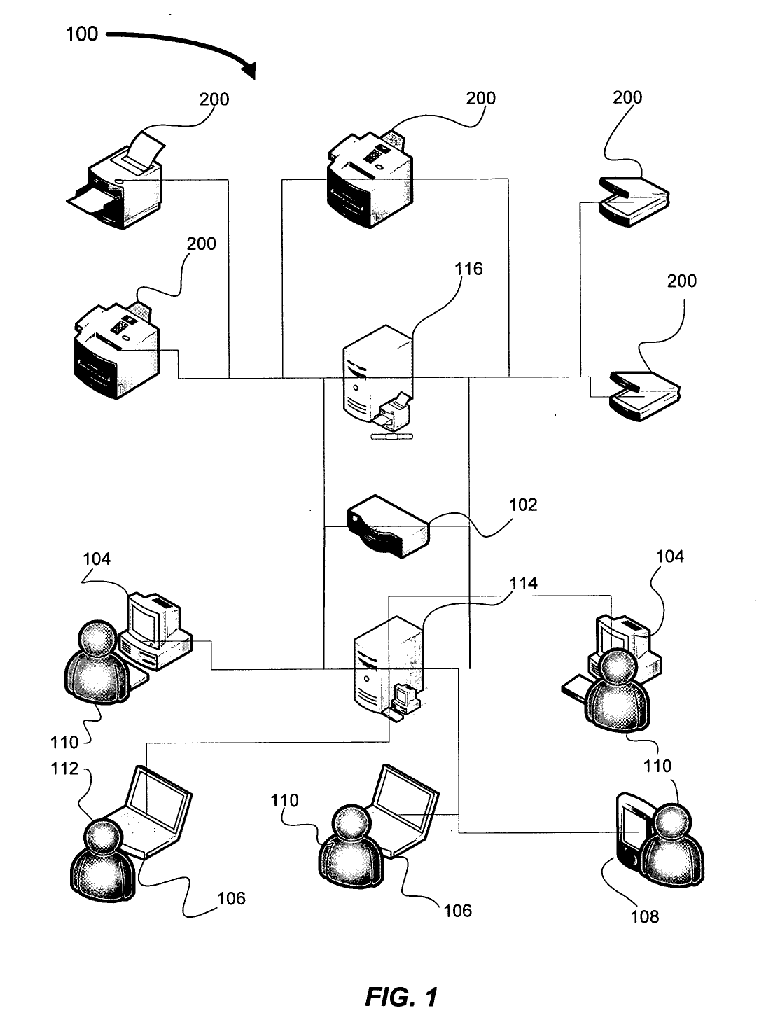

FIG. 1 depicts a network environment 100 suitable for practicing various aspects of certain inventive embodiments. The network environment 100 may be one of various types of networks. In one embodiment, the network environment is a local area network (LAN) environment in which various network components are in data communication using at least one network access device, e.g., a router 102. The router 102 may be configured to route packets and other network data from a source to a destination in the network environment 100. The router 102 may be a standard commercial router capable of handling various network protocols that is well known in the art, or it may be a customized routing device designed to route a specific type of network traffic IP packets, for example.

The network environment 100 may also include computer workstations 104. The computer workstations 104 may include desktop computers running a desktop operating system such as Windows®, Mac/OS®, or Linux, for example. The workstations 104 may be configured to access the network and other network components via a network interface card. The network interface card may provide a wired or a wireless connection, or both. Also present in the network environment 100 may be one or more mobile computers 106. The computers 106 may also connect to the network environment via a network interface module such as a network card, and data sent from the mobile computers 106 may be routed by the router 102 to other devices attached to the network environment. Also attached to the network may be handheld computing devices 108. The handheld computing devices 108 may also interface with the network environment. Handheld computing devices 108 may take the form of cell phones, personal digital assistants, tablet computers or some other similar device. The handheld computers 108 may run an operating system such as Windows Mobile, Symbian®, PalmOS®, or some other proprietary operating system. The computing devices accessing the network environment 100 may be operated by users 110. The users 110 access data and functionality from the network environment via the workstation, mobile computer, or handheld device with they use. The users 110 typically will have limited access rights on the network, meaning that they do not have the ability to reconfigure other devices on the network. Certain persons, such as system administrators, for example, may require increased access rights when accessing the network environment 100. These types of users may be characterized as power users 112. As shown in FIG. 1, a power user 112 uses mobile computer 106 to access the network environment 100. The network environment may also include various hardcopy output devices 200 that may produce hardcopy output or digitize hardcopy input. The hardcopy output devices 200 may be in data communication with various other network entities such as the computing devices described above. Hardcopy output devices 200 may take the form of printers, scanners, copiers, multi-function peripherals (MFPs), or some other device that permits conversion of digital data into hardcopy output (or vice versa). A multi-function peripheral (MFP) device is a single integrated device configured to perform two or more functions, including without limitation scanning, copying, printing, faxing, combinations of the same and the like. The functionality of a MFP device may be accessed over a network, including, for example, the Internet or a LAN, or at the device itself. A MFP device may be configured with sufficient memory to queue jobs waiting to be processed. It will be appreciated that MFP devices may be configured to perform in a variety of different networked and standalone computing environments.

The network environment 100 may also include various servers which may collect and store data utilized by the other network devices. For example, the network environment 100 may include one or more file servers 114 which store data which may be accessed by the other devices in the network environment. The file servers 114 may be configured to run a network operating system such as Unix, Linux, Windows®, Novell and are accessed by to output hardcopies of digital data stored on a device in the network environment 100.

The network environment may also include one or more print servers 116. The print servers 116 may take the form of a host computer or device to which one or more printers are connected. The print server 116 can accept print jobs from external client computing devices which are connected to the print server over the network environment 100. The print servers 116 send the data comprising the print jobs to the appropriate hardcopy output device. The print servers 116 may be a host computer running Windows® operating system with one or more shared printers. Client computers may use a network printing protocol such as the Microsoft® Network Printing protocol. Alternatively, the print servers 116 may also include computers running some operating system other than Windows® but still implementing Microsoft Network Printing protocol utilizing some emulation software such as Samba running on a UNIX or Linux computer.

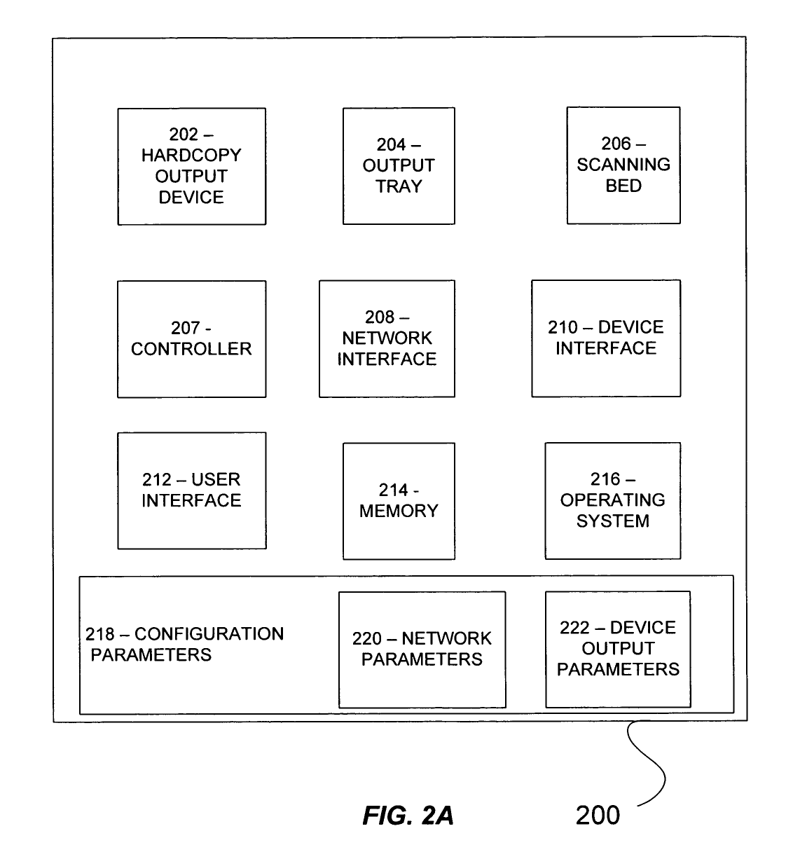

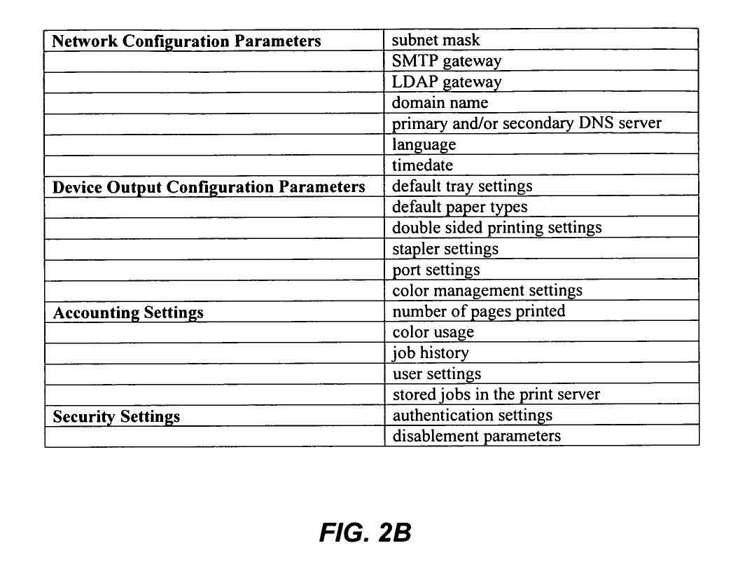

With reference to FIG. 2A, a block diagram showing various functional components of an illustrative hardcopy output device 200 is provided. Although FIG. 2 provides a description of various components in the hardcopy output device 200, a skilled technologist will appreciate that there are various configurations for hardcopy output devices, and that not all of the components described herein are necessarily present in each device. Moreover, devices may include other operative components not shown in FIG. 2.

The hardcopy output device may include a paper tray 202 which may be used to hold the material on which hardcopy output is produced. The device 200 may also include an output tray 204 where the finished paper product is placed for retrieval by a device user 110. Some hardcopy output devices 200 may include a scanning bed 206. The scanning bed 206 typically is a glass surface which allows a scanning apparatus to scan and reproduce copies of documents placed on the glass surface. The hardcopy output device 200 may further include a controller 207. The controller 207 may be a microprocessor unit which is configured to control various components and functions of the device 200. The hardcopy output device 200 may also include a network interface 208, typically wireless or Ethernet, which allows it to serve as a hardcopy device 200 for users 110 on the network. The network interface 208 may be in data communication with the controller 207 and may also provide a channel for communication between the hardcopy output device 200 and the print server 116.

The hardcopy output device 200 may also include one or more device interfaces 210 such as a USB port, parallel port, or some other port. These ports may be used to communicate directly with other computing devices such as handheld computers 108, mobile computers 106 or workstation computers 104. In addition, the device interface 210 may also allow the hardcopy output device 200 to directly interface to electronic media such as memory sticks or memory cards, or to image capture devices such as digital cameras, scanners.

The hardcopy output device 200 may further include a user interface 212. The user interface 212 may take various forms. In some embodiments, it may take the form of a touch screen user interface which includes a series of menus and options for a user 110 to select. The user interface 212 is typically located on an external surface of the hardcopy output device, and is typically available to configure the device. The user interface 212 may also be a simpler interface having a monochrome LCD screen and one or more user selectable buttons for configuring the device.

The hardcopy output device 200 may also include a memory 214. The memory 214 may take the form of random-access memory, fast access memory, firmware, hard disk space, a ROM (Read-Only Memory), an EEPROM (Electrically Erasable Programmable Read-Only Memory) or some other storage media. The memory may include volatile or non-volatile memory, or both. Stored on the memory 214 may be an operating system 216 which may include computer executable instructions which may allow the software components and hardware components of the hardcopy output device 200 to work together. The memory 214 may also store configuration parameters 218. Configuration parameters 218 are device settings that are generally modifiable and which are used to provide instructions to the device 200 for how it should operate and interact with its environment.

FIG. 2B provides an illustrative table of various configuration parameters 218 that may be stored within the memory 214 of the hardcopy output device 200. The hardcopy output device 200 may have configuration parameters which are used to manage its networking functions. Network configuration parameters 220 may include settings such as subnet mask, SMTP gateway, LDAP gateway, domain name, primary DNS server, secondary DNS server, WINS server, language, time/date server, and other settings. The settings may be accessible via some network protocol such as simple network management protocol (SNMP) or possibly a proprietary network protocol configured to allow the querying of hardcopy output devices 200 for their configuration parameter settings.

The configuration parameters 218 may also include device output parameters 222. Device output parameters may include default tray settings, default paper types, and double sided printing settings, stapler settings, port settings, color management settings, or some other setting related to the input or output functionality of the hardcopy device 200. The configuration parameters 218 may also include accounting information such as number of pages printed, color usage, job history, user settings, and stored jobs in the print server. Security settings may also be provided in the configuration parameters 218. For example, the configuration parameters may include data indicative of the types of users that can access certain features on the device. The configuration parameters may also include authentication settings which require users to authenticate to the device. Other parameters may include feature disablement parameters such as parameter data that restricts the use of certain features to certain users. For example, the ability of all users to access color printing features may be restricted to preserve more expense color toner, thereby providing cost savings in a printing environment in which the printers are heavily used.

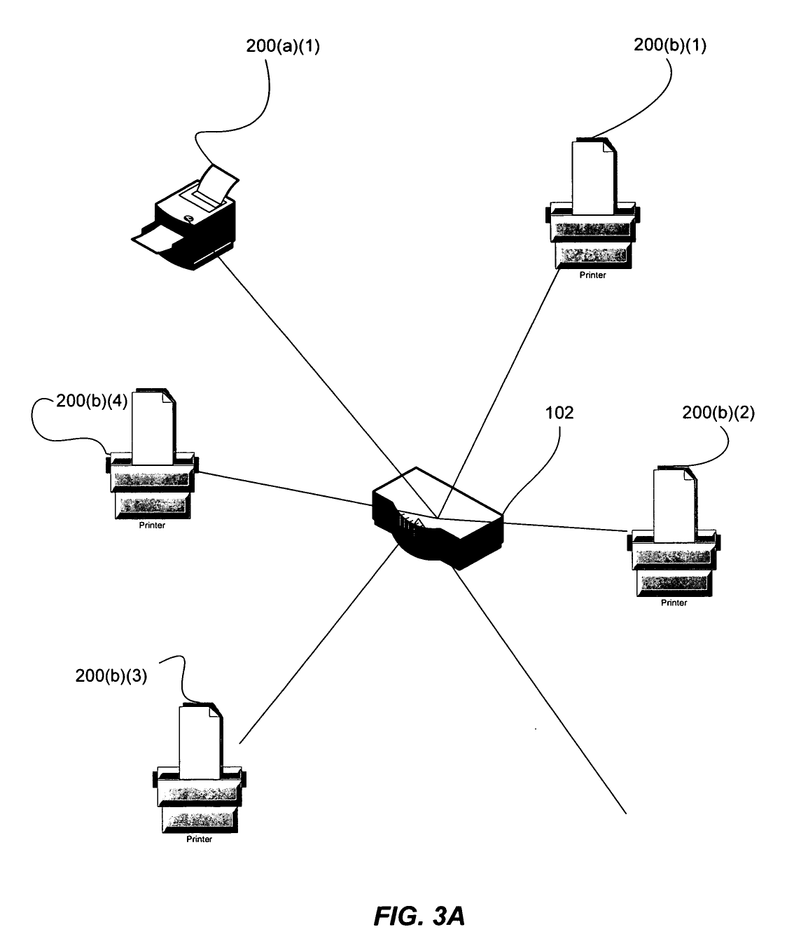

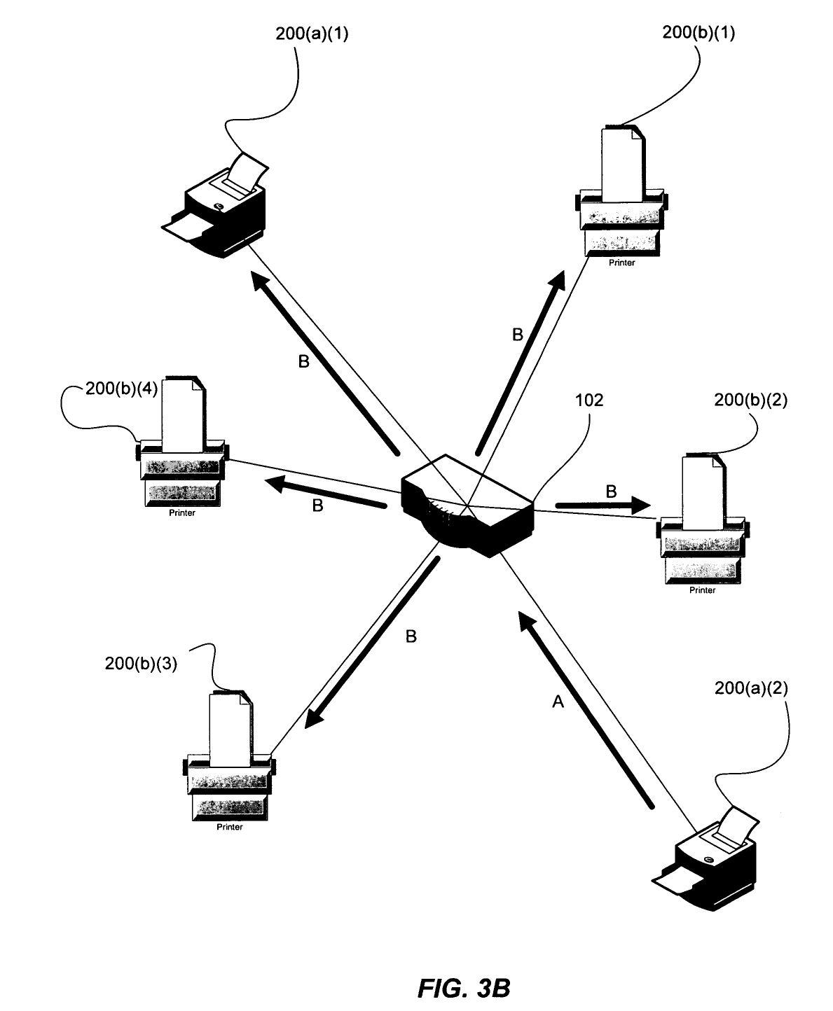

Various embodiments of the invention provide for the automatic configuration of a hardcopy output device 200 added to network environment 100. FIGS. 3A and 3B provide an example of a network environment 100 having two types of hardcopy output devices. Each different type of hardcopy output device is indicated by the letter following the number “200” in the figure. Thus, 200(a) represents a type of device, while 200(b) represents another type of hardcopy output device.

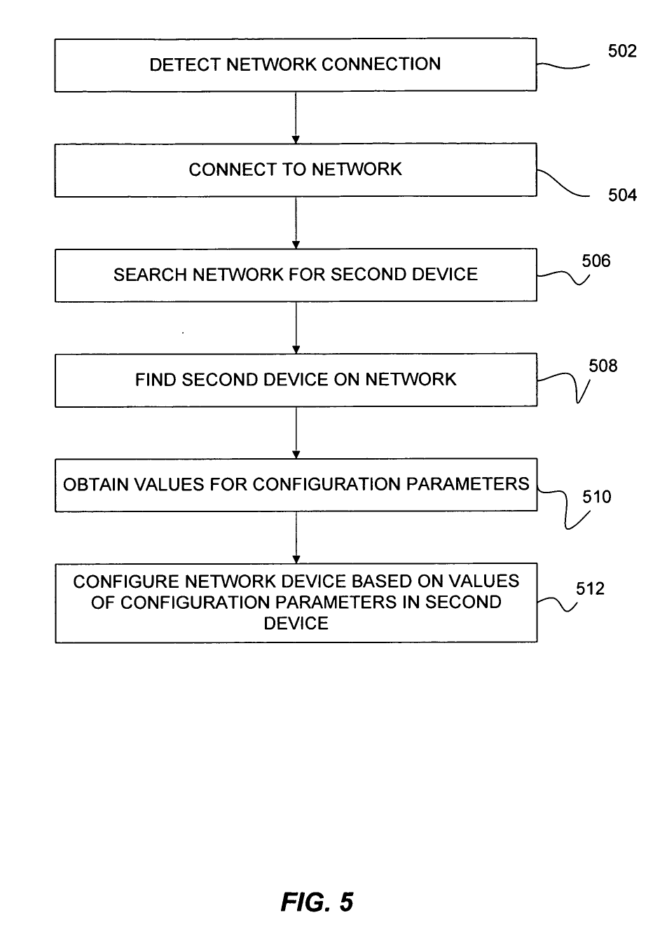

In one or more embodiments, a hardcopy output device 200 may be automatically configured when added to the network environment 100. FIG. 3A shows the network environment 100 with 5 previously added hardcopy output devices 200(a)(1) and 200(b)(1)-(4). Thus, there are four hardcopy output devices of type 200(b) and one of type 200(a). Referring now to FIG. 3B, a new hardcopy output device 200(a)(2) has been added to the network. As will be discussed in further detail below in reference to FIGS. 5-7, the new device sends broadcast messages to the network seeking to locate a compatible device type from which it may receive configuration parameter values. A broadcast signal 300 is sent from the newly added device 200(a) to the router 102 as indicated by the arrow “A.”. The router redirects the signal to each of the other devices on the network as indicated by the arrows “B”. The signal may include a request for an identifier of the device type of each of the other hardcopy output devices 200 in the network environment 100. Those devices capable of recognizing the signal and having compatible configuration parameters may respond by sending configuration parameter values to the requesting device. Thus, in the example provided in FIG. 3B, device 200(a)(1) will respond to a broadcast sent from device 200(a)(2).

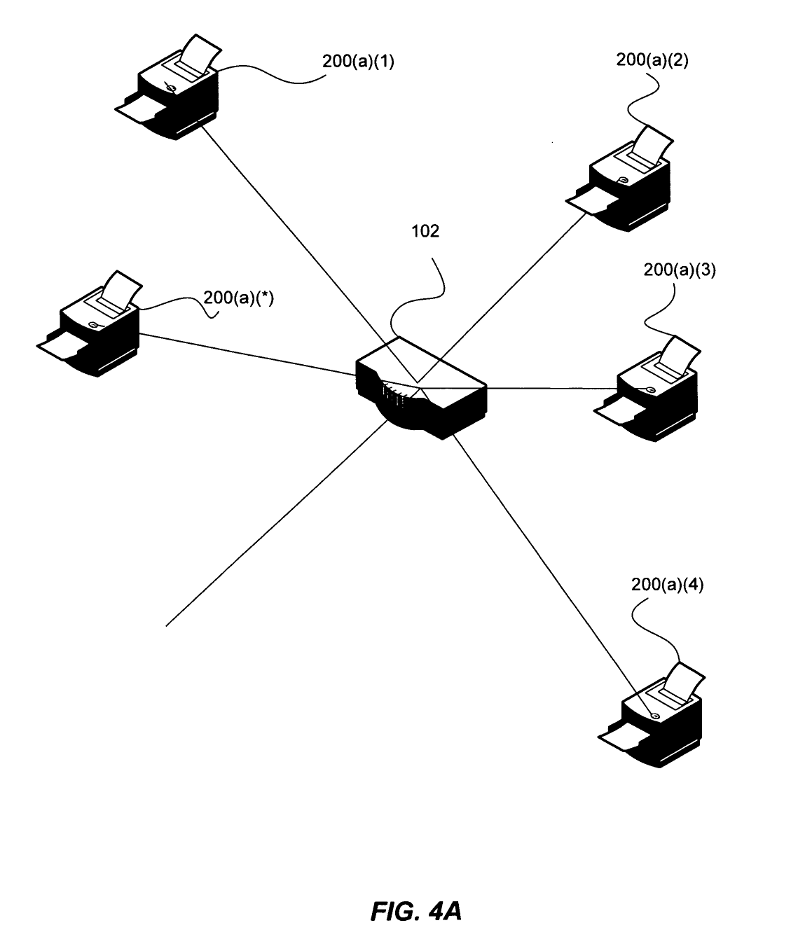

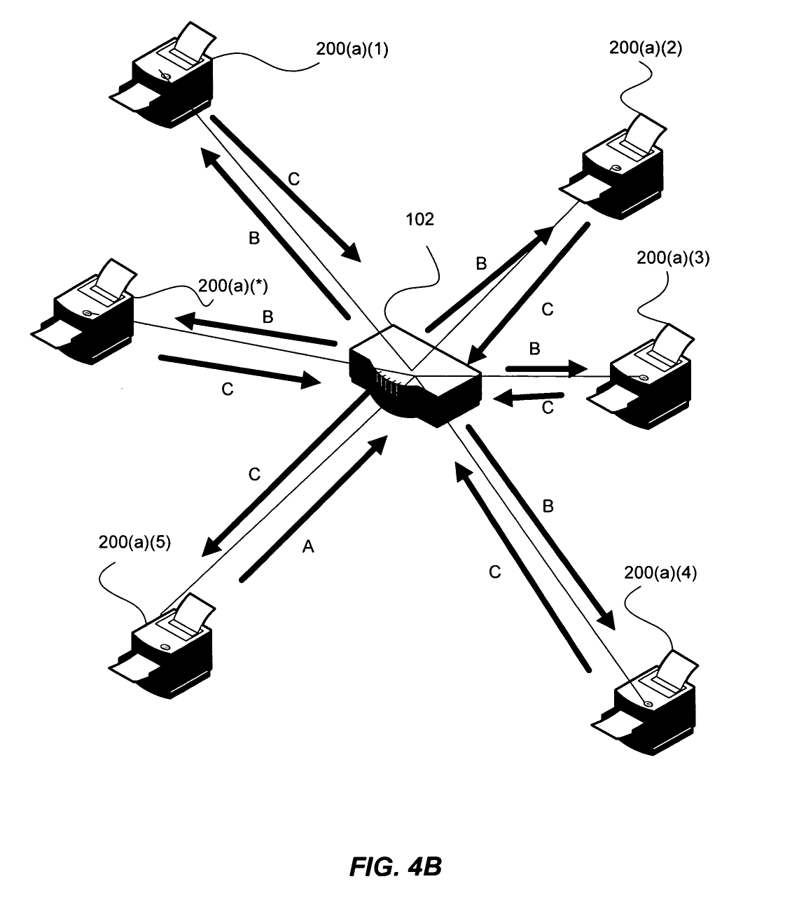

In some instances, there may be more than one hardcopy output device which has configuration parameter values 218 which are compatible with an output device 200 newly added to the network environment 100. It may be desirable to designate one or more of the compatible devices 200 as being a primary configuration device which will distribute settings to other like devices on the network 100 so that devices that have been manually altered from a base configuration are not sending inappropriate values. FIGS. 4A and 4B provide an example of such a configuration.

As shown in FIG. 4A, the network environment includes several hardcopy output devices 200 which are of the same device type, 200(a). One of the devices, 200(a)(*) is designated as the primary configuration device. The primary configuration device 200(a)(*) is configured to respond to any request for configuration parameter values 218. The other devices, which may be characterized as secondary configuration devices 200(a)(1)-200(a)(4) may also be configured to respond to requests, but the values provided by the primary device 200(a)(*) may be given higher priority in determine which of the received values to use.

Referring now to FIG. 4B, a new hardcopy output device 200(a)(5) is shown added to the network environment. As with the system described above in connection with FIG. 3, upon connection to the network environment, the newly added device 200(a)(5) sends a broadcast out to the network seeking configuration values as indicated by the arrow A. The devices receiving the broadcast message from the newly added device 200(a)(5) respond to the broadcast by sending a set of configuration parameters 218 back to the newly added device, as indicated by the arrows C. The newly added device receives the configuration parameter values from the devices and sets it own values accordingly.

Although the configurations provided in FIGS. 3 and 4 illustrate embodiments in which newly added network hardcopy output devices 200 receive configuration values from similar device types, a skilled technologist will appreciate that the configuration parameter values shared among various devices need only be compatible with each other, and that devices need not be identical type of hardware. Thus, if a device of one type includes configuration parameter values 218 compatible with a device of another type, then the values 218 may be shared among the devices.

FIG. 5 provides an illustration of a process by which a hardcopy device such as the device 200(a)(5), for example, may be configured when added to a network such as network environment 100. As discussed above, this connection may be provided by a network interface 208, and may be a wireless or a wired connection. At block 502, the hardcopy device 200(a)(5) detects a network connection. Next, the hardcopy device 200(a)(5) connects to the network environment 100 at block 504. In one embodiment, the hardcopy device may receive an IP address from a DHCP server, allowing it to connect to the network 100. The process proceeds to block 506, where the device 200 searches the network for a second device such as the hardcopy output device 200(a)(*), for example, from which it may request configuration parameter values 218. At block 508, the second device 200(a)(*) is located on the network 100. Next, at block 510, the first device 200(a)(5) receives configuration parameter values 218 from the second device 200(a)(*). As discussed above, these configuration parameter values may include network configuration parameters 220, or device output configuration parameters 222. Having received the configuration values, at block 512, the newly added device 200(a)(5) then configures itself based on the values received from the second device.

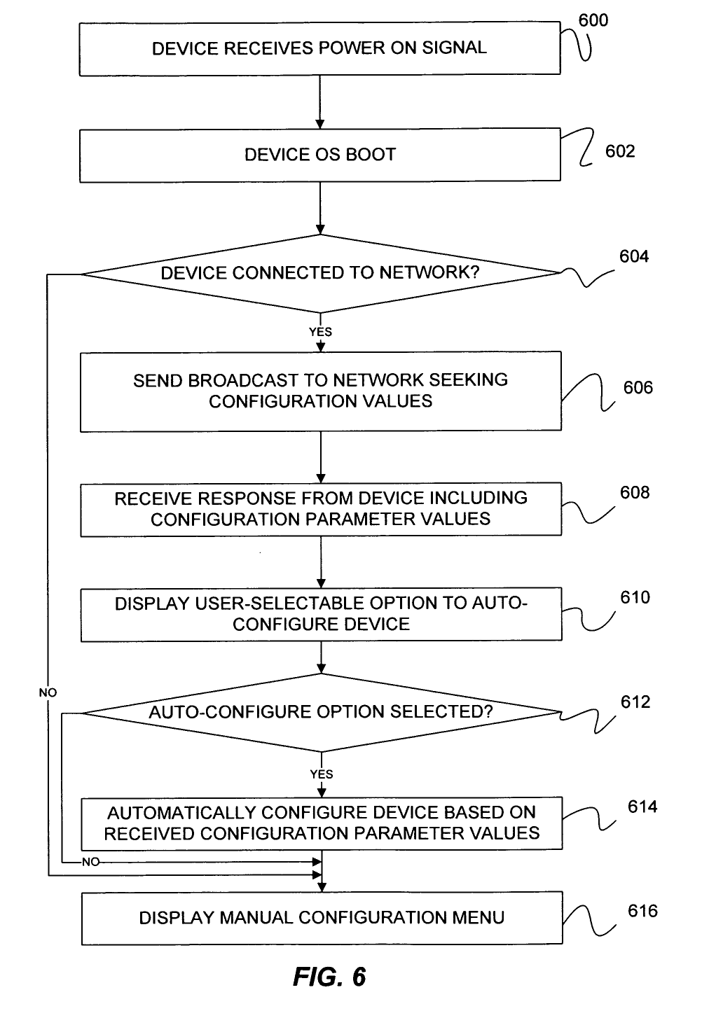

In another embodiment, the device 200 may be configured to allow a user operating the device to select whether to utilize an automatic configuration process or to manually configure the device. FIG. 6 provides an illustration of such a process. At block 600, the device to be configured, such as device 200 for example, receives a power on signal. In certain embodiments, the power on signal can be from a user actuating a power switch on the device, or from the device being plugged into a power source. Once the device 200 has been powered on, an operating system 216 stored on memory 214 may initiate its start up sequence.

In one or more embodiments, the device OS startup sequence may include computer executable instructions which cause the device to determine whether it is connected to a network at decision block 604. If the device is not connected to a network environment 100, the process skips to block 616, where it displays a manual configuration menu on its user interface 212. If the device detects a network connection, the process moves to block 606, where the device 200 sends a broadcast message to the network seeking configuration parameter values 218. One or more devices in the network may then receive the broadcast message, and respond by sending a set of configuration parameter values 218 to the requesting device 200. The device 200 then receives the parameters at block 608, and displays a user-selectable option to automatically configure the device at block 610. The user selectable option may be displayed on the user interface 212, and may take the form of text displayed on the user interface 212, or in other embodiments could be a voice command or some other form of communication to the user. Next, the process moves to decision block 612. If the auto-configuration option is selected, the process moves to block 614, where the device 200 is automatically configured based on the received configuration parameter values 218. If the auto-configuration option is not selected, the process moves to block 616 where the manual configuration menu is displayed on the user interface 212.
Although this system and method discussed herein have been described in the context of hardcopy output devices, a skilled technologist will appreciate that the systems and methods described may be utilized with other types of devices. For example, network routers 202 may be configured to receive configuration parameters settings from other routers. Workstation computers 104, mobile computers 106, handheld computers 108, and servers 112 and 114 may also automatically configure themselves based on devices already present in the network environment. Moreover, in some embodiments, items other than configuration parameter values may be received. For example, in some embodiments, software applications may be sent from a first device to a similar second device for installation on the device's operating system. It will further be understood by those of skill in the art that numerous and various modifications can be made without departing from the spirit of the present invention. Therefore, it should be clearly understood that the forms of the invention are illustrative only and are not intended to limit the scope of the invention.

What is claimed is:

1. A method of configuring a device having a hardcopy output capability on a data communications network, the method comprising:
searching the network for a configured device having a hardcopy output capability, the configured device having configuration parameters applicable to the device;
finding the configured device on the network;
obtaining values for the configuration parameters from the configured device via the network; and
configuring the device based on the values for the configuration parameters of the configured device.

2. The method of claim 1, wherein searching the network for the configured device comprises broadcasting a message to the network.

3. The method of claim 1, wherein the device and the configured device are multifunction peripheral devices (MFPs).

4. The method of claim 2, wherein finding the configured device comprises receiving a network response indicative of device similarity from the configured device.

5. The method of claim 4, wherein the response indicative of device similarity comprises a device model number.

6. The method of claim 5, wherein the device model number is the same for the device and the configured device.

7. The method of claim 1, wherein obtaining values for the configuration parameters of the configured device comprises:
querying the configured device for the values for the configuration parameters; and
receiving the values for the configuration parameters from the configured device.

8. The method of claim 7, wherein querying the configured device comprises sending an SNMP message to the configured device.

9. The method of claim 8, wherein the received values include at least one of a subnet mask, a SMTP gateway, an LDAP gateway, a domain name, a DNS server, a WINS server, a language, and a time/date setting.

10. The method of claim 9, further comprising:
displaying, prior to searching the network, a user-selectable command on the network device to automatically configure the device on the network; and
receiving a user command to automatically configure the device on the network.

11. The method of claim 1, wherein searching the network comprises executing device firmware when the device is booted.

12. The method of claim 1, wherein searching the network comprises executing instructions stored in a boot sequence of an operating system of the network device.

13. An automatically configurable network device having a hardcopy output capability, the device comprising:
a hardcopy output subsystem;
a network interface module configured to send and receive data from a data communications network;
a storage module configured to store instructions which when executed cause the network device to send a broadcast message to the network, obtain configuration settings from a storage network device and store the configuration settings received through the network interface module; and
a user interface configured to display a notification when the network device is automatically configured.

14. The automatically configurable network device of claim 13, wherein the network interface module is further configured to detect a network connection of the device.

15. The automatically configurable network device of claim 14, wherein the broadcast message includes a request for the configuration settings from other devices on the network.

16. The automatically configurable network device of claim 15, wherein the configuration settings include one or more of network configuration parameters, device output parameters, or security settings parameters.

17. The automatically configurable network device of claim 16, wherein the stored instructions are stored in firmware of the device.

18. The automatically configurable network device of claim 13, wherein the user interface is further configured to provide a user-selectable option to automatically configure the device.

19. The automatically configurable network device of claim 13, wherein at least some of the configuration settings received through the network interface module from another device on the network are received from a primary configuration device.

20. The automatically configurable network device of claim 19, wherein additional configuration settings received through the network interface module are received from secondary configuration devices.

21. The automatically configurable network device of claim 20, wherein the configuration settings received from the primary configuration device are given priority over the configuration settings received from the secondary configuration device.
